(19) United States
(12) Patent Application Publication
(10) Pub. No.: US 2019/0231617 A1
(43) Pub. Date: Aug. 1, 2019

(54) MOBILITY ASSISTANCE VEHICLE DESIGNED TO NEGOTIATE OBSTACLES

(71) Applicant: Christophe Cazali, Viroflay (FR)

(72) Inventor: Christophe Cazali, Viroflay (FR)

(21) Appl. No.: 16/340,501

(22) PCT Filed: Oct. 9, 2017
(86) PCT No.: PCT/FR2017/052763

§ 371 Date: Apr. 9, 2019

(30) Foreign Application Priority Data
Oct. 10, 2016 (FR) 1670589

(51) Int. Cl. A61G 5/06

(52) U.S. Cl. CPC A61G 5/068; A61G 5/1059; A61G 5/061

(57) ABSTRACT

The invention mainly concerns a mobility assistance vehicle (1) designed to negotiate obstacles (33, 35) while keeping the attitude of same horizontal, comprising a mechanical structure (2) supporting at least one seat (3), control means (19), at least four articulated legs (6a, 6b, 6c, 6d) and equipped with motorised wheels, characterised in that: i. each first segment (7a-7d) is mounted on one of the lateral sides (200) of the mechanical structure (2) by a motorised articulation (10a, 10b, 10c, 10d), each opposing lateral side (200) being linked to at least two legs (6a-6d), and in that, ii. the control means (19) are capable of controlling the motorised articulations (9a -9d, 10-10d) of the legs (6a-6d) separately from each other, in particular when said legs (6a-6d) are raised successively in order to negotiate an obstacle (33, 35) in a permanently stable situation.

The invention lies in the field of mobility assistance vehicles, such vehicles being motorized and controllable by way of control means integrated into the vehicle.

The invention relates more particularly to a mobility assistance vehicle, for example a wheelchair or a stroller, adapted in particular to travel over uneven and sloping or banked terrain and to negotiate obstacles freely. A vehicle of this kind therefore gives the person in control of it enhanced autonomy.

Motorized vehicles of this kind, such as electric wheelchairs, conventionally have no capacity to negotiate obstacles more than a few centimeters high. There nevertheless exist specific devices extending these limits in part.

There is known for example from the document FR2618066 a self-propelled wheelchair for the disabled with an automatic verticalization device. The wheelchair includes an adjustable seat disposed on a box and a plurality of caterpillar tracks running around notched rollers, the tracks being connected to the frame of the seat by legs articulated to said frame by pivot articulations motorized by means of cylinders. Also, each leg includes a second pivot articulation.

However, the above self-propelled wheelchair has the disadvantage of including a very heavy and very complicated mechanism and is able to negotiate obstacles only of low height.

There is likewise known from the document JP11128278 a wheelchair including four articulated legs with a pantograph type mechanism, the legs being fixed by one end under the seat of the wheelchair and including at the other end a wheel with an integrated electric motor. The articulations of the legs are moreover motorized by cylinders. However, this wheelchair has limited overall and lateral stability because of its general structure and in particular the arrangement of the articulated legs. Also, this type of wheelchair is not able to negotiate obstacles of great height or depth because of the small capacity for forward extension of the front axle wheels.

The invention therefore aims to propose a mobility assistance vehicle such as a wheelchair or a stroller adapted to negotiate obstacles of great height that it encounters whilst assuring optimum stability of the wheelchair when negotiating said obstacle.

To this end, the mobility assistance vehicle includes a mechanical structure supporting at least one support plate, control means, at least four articulated legs each including first and second segments interconnected by a first motorized articulation, one end of each first segment being mounted on the mechanical structure, the vehicle further including motorized wheels respectively mounted on respective free ends of the second segments, characterized in that:

i. each first segment is mounted on one of the lateral sides of the mechanical structure via a second motorized articulation, each opposite lateral side being connected to at least two legs, and in that

ii. the control means are adapted to control independently of one another the first and second motorized articulations of the legs, in particular by successively lifting said legs to negotiate an obstacle.

The mobility assistance vehicle of the invention may also have the following optional features separately or in all technically possible combinations:

Each first segment is mounted in the lower part of the mechanical structure.

Each first and second motorized articulation is driven by a dedicated actuator controlled by the control means, the actuator taking the form for example of an electric motor or a hydraulic or electric cylinder.

The actuators each include a position sensor connected to the control means so that said control means know and control in real time the spatial coordinates of each wheel of the vehicle relative to the mechanical structure of the vehicle.

The vehicle includes means for detecting inclination of the support blade relative to a horizontal plane, these inclination detection means being connected to the control means, and the control means are adapted to control the actuators to adjust the position of the legs the wheels of which are in contact with the ground so that the angle of inclination of the support plate relative to the horizontal plane is less than a particular angle value.

The control means are adapted to calculate in real time the spatial coordinates of the center of gravity of the vehicle from data coming from the position sensors of the actuators.

The control means are adapted, before lifting a leg, to command the position of the center of gravity of the wheelchair by commanding the actuators to modify the position of the legs so that the projected coordinates of the center of gravity in the horizontal plane are included within a support polygon defined by the projected coordinates in said plane of the wheels intended to remain in contact with the ground after lifting the leg concerned.

The vehicle includes a three-dimensional vision system controlled by the control means and adapted to detect at least one obstacle to be negotiated by the vehicle, the vision system enabling determination of the distance from the obstacle to the vehicle and at least one vertical coordinate of the obstacle representing its height.

Each front wheel of the vehicle is articulated about a longitudinal axis of the corresponding segment and the rotation of each wheel about that longitudinal axis is controlled by the control means to enable the vehicle to be oriented.

Each wheel includes an angle sensor connected to the control means and adapted to measure the angle formed between the rotation axis of the wheel concerned and a longitudinal axis of the vehicle.

The articulations of the legs each include at least one substantially horizontal and transverse rotation axis.

The support plate is a seat of said vehicle.

The invention is also directed to a method for controlled negotiation of obstacles by successively lifting the legs of the vehicle as described above, characterized in that it includes at least the following steps:

i. determination by the control means of the coordinates of the center of gravity of the vehicle as a function of various data coming from the position sensors of the actuators and as a function of the dimensions and masses of the elements constituting the vehicle and where necessary carried by said vehicle;

ii. detection by the control means of the wheels bearing on the ground as a function of the data supplied by force sensors respectively fastened to the wheels and selection by the control means of the wheels that are to continue to bear on the ground after lifting the wheel to be lifted;

iii. definition of the coordinates of a support polygon formed by the projection of the coordinates of the wheels remaining in contact with the ground in the horizontal plane;

iv. actuation by the control means of the actuators to move the center of gravity so that its projected coordinates are included in the support polygon previously defined, and

v. lifting of the wheel concerned by the actuators concerned controlled by the control means.

The method may likewise have the following optional features separately or in all technically possible combinations:

The support polygon defined before lifting the wheel concerned is a triangle, the vehicle (1) having four legs.

The successive steps i to iv are repeated in a loop so that the determination of the coordinates of the center of gravity and the maintaining of its position in the corresponding support polygon are carried out in real time and in each step of the loop.

The method includes a preliminary step of determination of the initial coordinates of the center of gravity of the vehicle including at least the following substeps:

i. actuation by the control means of the actuators of the articulations of the two front or rear legs to extend the latter in the longitudinal direction so that the center of gravity of the vehicle is situated in the vicinity of the front part or the rear part of the vehicle, the wheels all bearing on the ground (34) and the support plate being horizontal;

ii. lifting by the actuators concerned controlled by the control means of one of the two extended legs of the vehicle to lift the wheel concerned;

iii. actuation by the control means of the actuators of the articulations of the extended leg the wheel of which is bearing on the ground so as to move it progressively toward the vehicle;

iv. determination by the control means of the coordinates of the wheels bearing on the ground from the data coming from the position sensors of the articulations at the moment when the angle of inclination of the support plate relative to the horizontal plane reaches a particular value, the angle variation being analyzed by the control means with the aid of the data coming from the means for detection of inclination of the support plate;

v. assignment of coordinates to the center of gravity of the vehicle relative to the coordinates of the wheels bearing on the ground determined in the preceding step to form the initial coordinates of the center of gravity.

Other features and advantages of the invention emerge clearly from the description thereof given hereinafter by way of nonlimiting illustration and with reference to the appended figures, in which:

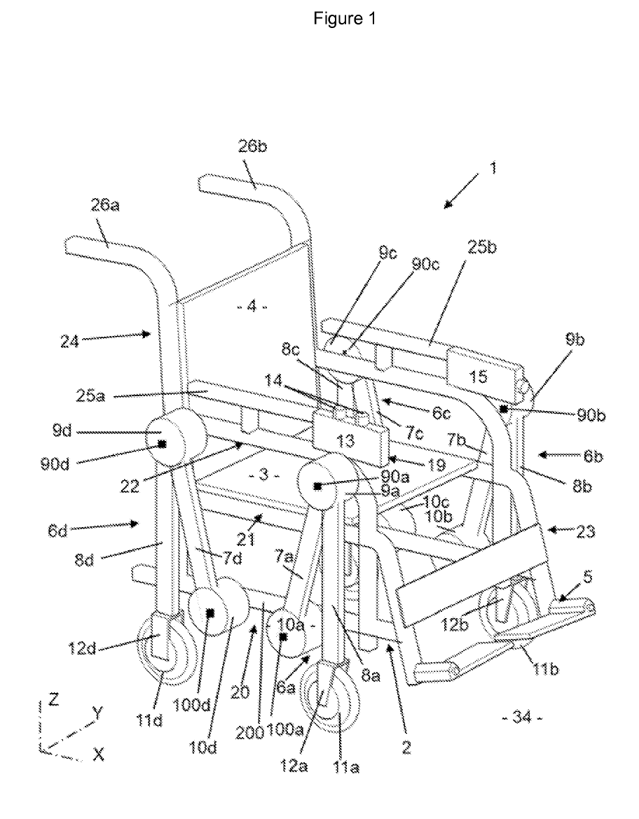

FIG. 1 is an overall perspective view of the mobility assistance vehicle according to one embodiment of the invention;

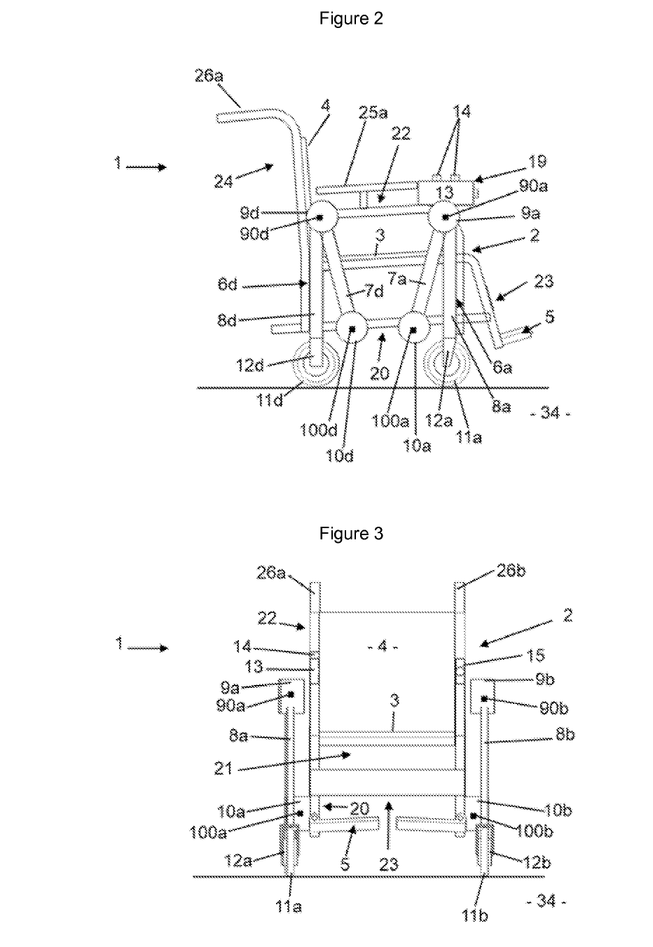

FIG. 2 is a side view of the vehicle from FIG. 1;

FIG. 3 is a front view of the vehicle from FIG. 1;

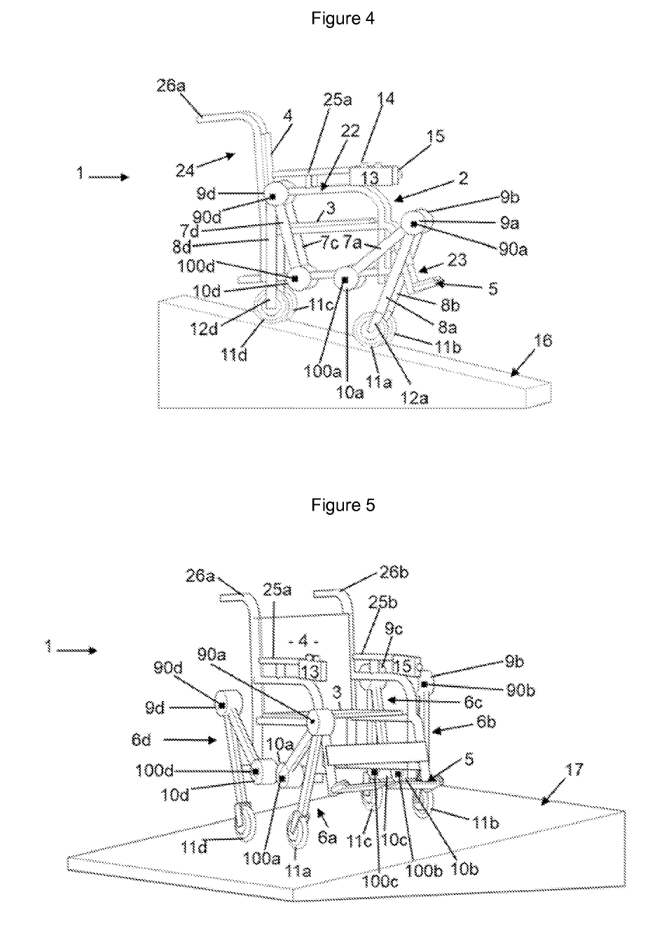

FIG. 4 shows the vehicle from FIG. 1 traveling on sloping terrain;

FIGS. 5 shows the vehicle from FIG. 1 traveling on banked terrain;

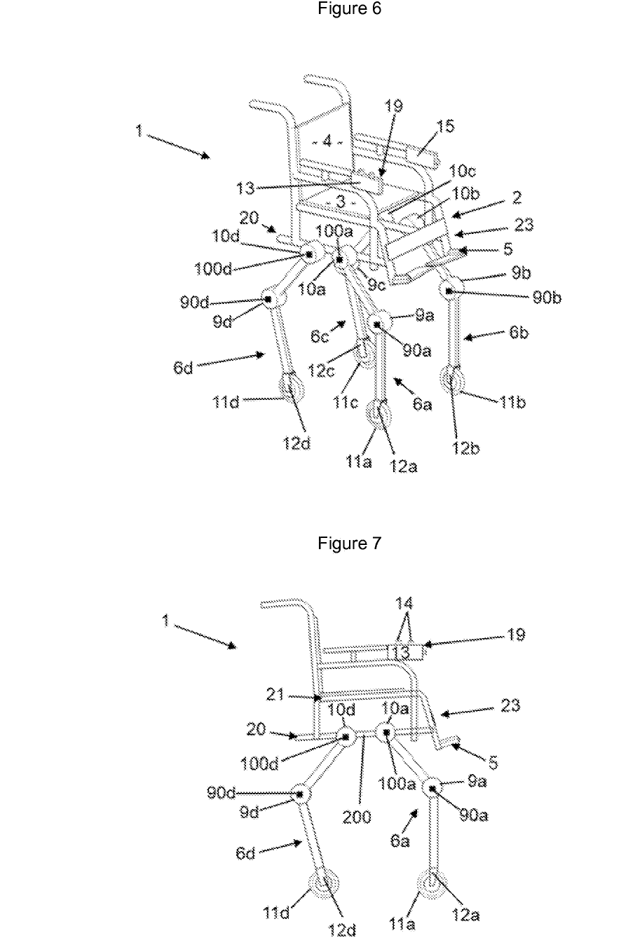

FIG. 6 is a perspective view of the vehicle according to the invention with the seat raised by extending the articulated legs of the vehicle;

FIG. 7 is a side view of the vehicle of the invention in its FIG. 6 configuration;

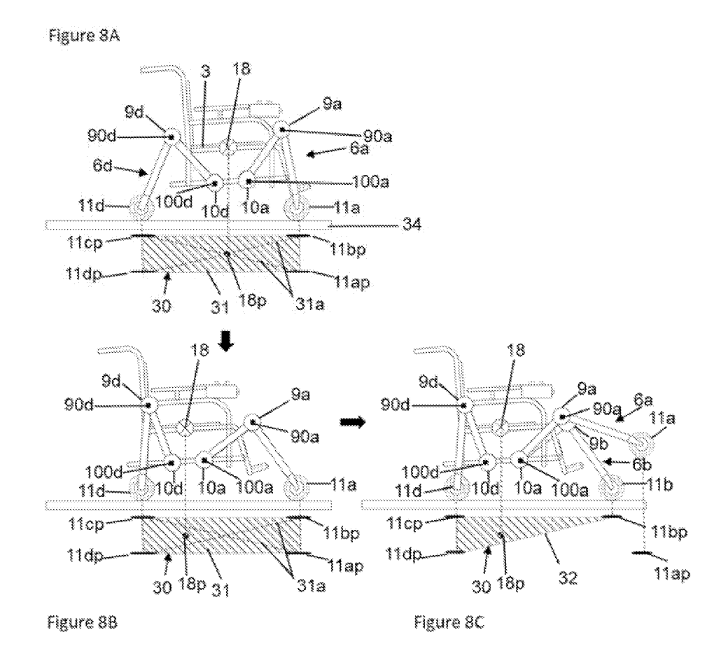

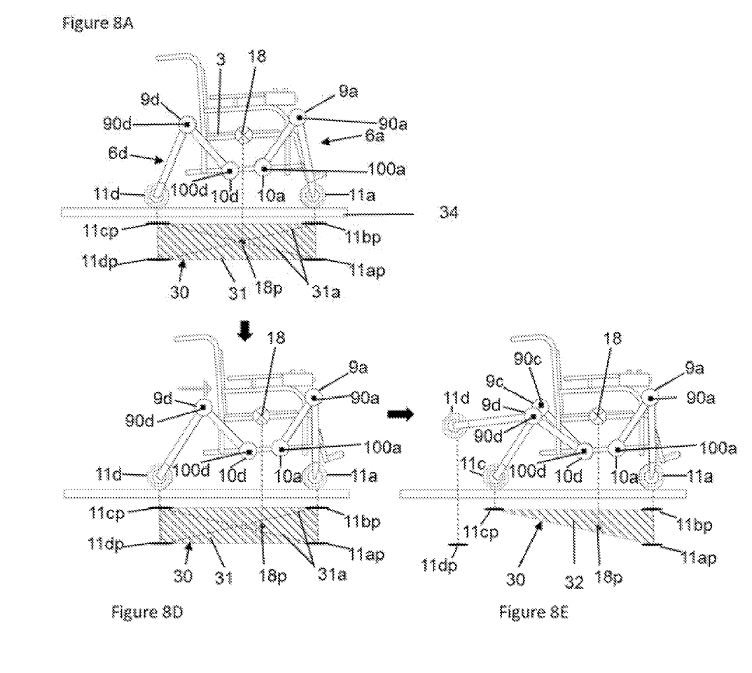

FIG. 8A shows the vehicle of the invention stable on four wheels and the projection of its center of gravity in a support polygon;

FIGS. 8B and 8C show, on lifting a front wheel, a kinematic of the movement of the center of gravity of the vehicle of the invention to move its projection into the support triangle formed by the three wheels remaining on the ground;

FIGS. 8D and 8E show, on lifting a rear wheel, a kinematic of the movement of the center of gravity of the vehicle of the invention to move its projection into the support triangle formed by the three wheels remaining on the ground;

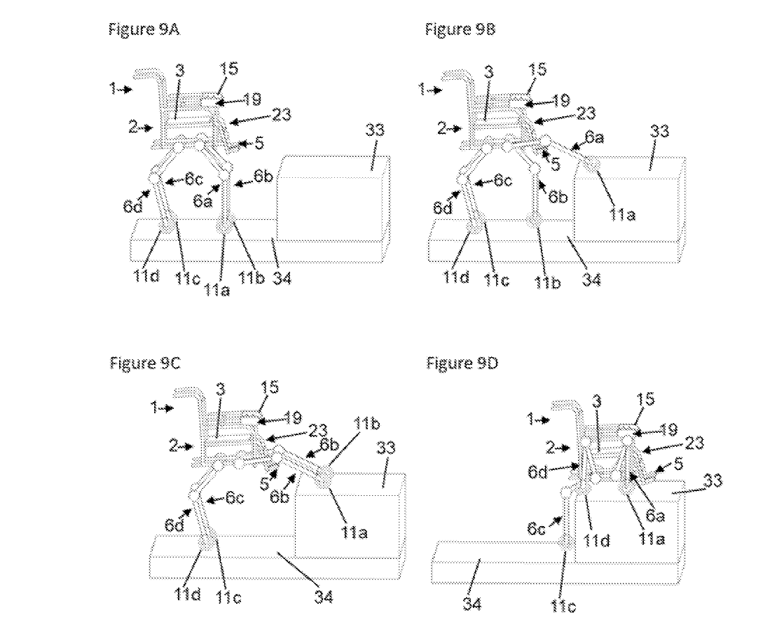

FIGS. 9A to 9D show a kinematic of the negotiation of an obstacle of great height by the vehicle of the invention;

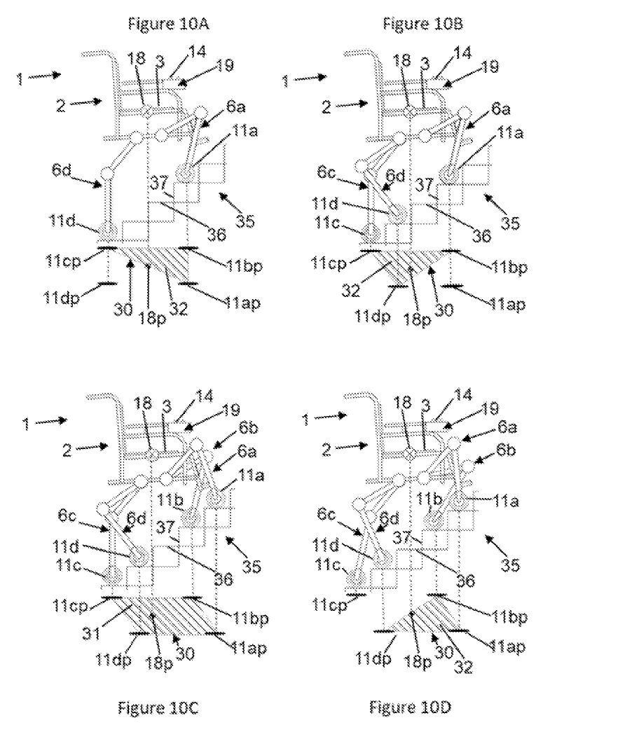

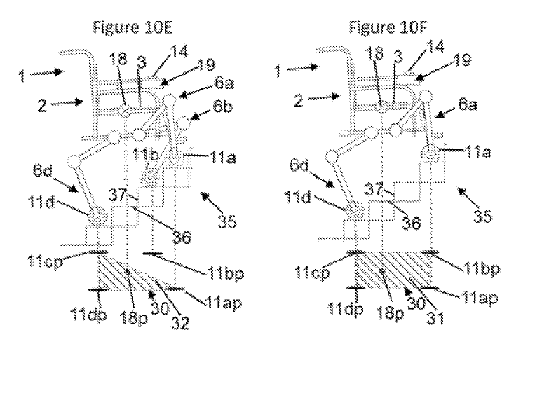

FIGS. 10A to 10F show a kinematic of the vehicle of the invention climbing a staircase.

It is specified first of all that in the figures the same references designate the same elements regardless of the figure in which they appear and regardless of the way in which those elements are represented. Likewise, if elements are not specifically referenced in one of the figures, their references may be easily found by referring to another figure.

It is also specified that the figures essentially represent one embodiment of the subject matter of the invention but that there may exist other embodiments that conform to the definition of the invention.

The present invention concerns a mobility assistance vehicle 1 adapted to ascend or descent a staircase, to negotiate raised or recessed obstacles (for example a gutter) whilst maintaining the seat horizontal even on sloping or banked terrain. Apart from negotiating obstacles, the vehicle of the invention further enables the seat to be raised to raise the passenger to the height of standing persons. This autonomy conferred upon the passenger or the user of said vehicle 1 is greatly enhanced: there is no requirement either for a third person or for a supplemental device to obtain the benefit of these capabilities.

With reference to the embodiment shown in FIGS. 1 to 3, the mobility assistance vehicle 1 of the invention is a motorized wheelchair including a mechanical structure 2 supporting at least one support plate 3, said plate being in particular a seat, and is compatible with all the arrangements necessary for a physically handicapped person (for example ergonomic adaptations of the seat, the seatback 4, the footrest 5).

The mechanical structure 2 is a metal chassis formed of structural sections, this chassis including in particular a lower part 20, an intermediate part 21 on which the seat 3 rests, a front part 23 to the edge of which the footrest 5 is fastened, and an upper part 22 supporting the armrests 25a, 25b. Finally, the mechanical structure 2 includes a rear part 24 on which the seatback 4 rests. This rear part 24 is also provided with two handles 26a, 26b to enable a non-invalide user to maneuver the wheelchair 1.

The wheelchair 1 is of the electrical type and in particular has an electric battery (not shown), wheels 11a, 11b, 11c, 11d each motorized by an integrated electric motor, and a control console 13 including at least one control stick 14, commonly referred to as a “joystick”, forming an integral part of the control means 19 of the vehicle. The console 13 enables the passenger in the wheelchair 1 to command it to go forward, to go back, to turn, to stop, to raise or to lower the mechanical structure and therefore the seat 3.

In the remainder of the description, and as shown in FIG. 1, the frame of reference is that of the wheelchair 1, which is a orthonormal frame of reference with three-axes, respectively directed in the vertical direction (Z), a longitudinal direction (X) of the wheelchair and a transverse direction (Y) of the wheelchair.

Referring to FIGS. 1 to 3, the wheelchair 1 includes four articulated legs 6a, 6b, 6c, 6d mounted to rotate on the lower part 20 of the mechanical structure 2. To be more precise, and in accordance with the invention, the two pairs of legs are respectively mounted on the two lateral sides 200 of the lower part 20 of the mechanical structure and on the exterior of the structure.

Each leg 6a-6d comprises first segments 7a-7d and second segments 8a-8d connected to one another at the level of two respective ends by a first articulation 9a-9d motorized by an actuator 90a-90d controlled by the control means 19. This articulation 9a-9d is preferably rotatable about a transverse axis, i.e. an axis parallel to the axis Y of the orthonormal frame of reference.

The first segment 7a-7d, which may be regarded as the “thigh” of the leg 6a 6d, is mounted on and rotates on the mechanical structure 20 at the level of its second end by a second articulation 10a-10d motorized by another actuator 100a-100d also controlled by the control means 19. This other articulation 10a-10d is also preferably rotatable about a transverse axis parallel to the axis Y of the orthonormal frame of reference.

The actuators 90a-90d and 100a-100d enabling movement of the two actuations 9a-9d and 10a-10d of the leg 6a-6d may be of electric motor or hydraulic or electric cylinder type.

The second segment of the leg 8a-8d, which may be regarded as the “tibia” of the leg 6a-6d, includes at its free end a wheel 11a-11d mounted on its fork 12a-12d and motorized for example with the aid of a hub motor (not shown). Moreover, the wheel 11a-11b is able to pivot about the longitudinal axis of the second segment 8a-8d to enable the wheelchair 1 to turn.

The control means 19 control the various actuators 90a-90d and 100a-100d of the articulations 9a-9d, 10a-10d of the legs 6a-6d and the motors enabling the wheels 11a-11d to move the wheelchair 1 or to cause it to turn. Commands can be sent in a controlled manner by the passenger via the joystick 14 of the control console 13 but may equally be sent automatically as a function of the environment around the wheelchair.

The control means 19 include a computer (not shown) that is adapted to take into account the orders of the passenger or the user via the control console 13 but also to take into account the state of the wheelchair (i.e. in particular the position of the legs 6a-6d, the wheels 11a-11d and the seat 3) and the surrounding obstacles to enable the computer to send automatic commands if required, for example for negotiating an obstacle 33, 35. The control means 19 also include a memory space in which the characteristics of the wheelchair 1 according to the invention are stored, in particular the various dimensions, positions and masses of the elements constituting it.

The wheelchair 1 therefore includes a plurality of means enabling the control means 19 to analyze the state of the wheelchair 1 and the surrounding obstacles.

To this end the wheelchair 1 includes a three-dimensional vision system 15, for example a stereoscopic vision system, or a lidar or radar type system, controlled by the control means 19. This system is preferably oriented toward the front of the wheelchair 1, in other words in the direction of the vision of the passenger in the wheelchair 1. Alternatively, this vision system 15 may equally be oriented in other directions. The vision system 15 is preferably integrated into one of the armrests 25b, the control console 13 being integrated into the other armrest 25a. The vision system 15 therefore makes it possible to characterize the obstacles 33, 35 coming into the field of view of the vision system 15, i.e. to define the position and the dimensions of the obstacle 33, 35 in the orthonormal frame of reference with axes X, Y and Z relative to the frame of reference of the wheelchair 1.

The first articulations 9a-9d and the second articulations 10a-10d of each leg 6a-6d are each provided with a position sensor (not shown) connected to the control means 19. As a result, the control means 19 are aware in real time of the state of the articulations 9a-9d, 10a-10d of each leg 6a-6d, which enables said control means 19, knowing the dimensions of all the elements of the wheelchair (in particular of the wheels 11a-11d, the segments 7a-7d, 8a-8d of the legs 6a-6d and the parts 20 24 of the mechanical structure 2), to deduce therefrom the position of each wheel 11a-11d of the wheelchair 1 in the system of axes X, Y and Z relative to the wheelchair 1. As a corollary of this, the control means 19 use the data from the sensors of the position of the articulations 9a-9d, 10a-10d to control the movement of the legs 6a-6d to a particular position. Alternatively, each position sensor may be integrated into the actuator 90a-90d and 100a-100d concerned.

Each wheel 11a-11d includes an angular sensor connected to the control means 19 and adapted to measure the angle formed between the rotation axis of the wheel and the transverse direction Y. The control means 19 use the data from the angle sensors to control the rotation of the wheelchair 1. Like the actuators 90a-90d and 100a-100d of the articulations 9a-9d, 10a-10d, the wheels 11a-11d are therefore controlled in a closed loop by the control means.

Each wheel 11a-11d further includes a force sensor (not shown) connected to the control means 19 to enable it to identify which wheel 11a-11d is bearing on the ground 16, 17, 34, 36.

Finally, the wheelchair is equipped with means (not shown) for detecting inclination of the seat 3 of the wheelchair 1 relative to a plane (X, Y), i.e. a horizontal plane. These inclination detection means, connected to the control means 19 and preferably positioned under the seat 3 and at its center, include for example a gyrometer or a gyroscope.

The control means 19 are therefore able to control the actuators 90a-90d and 100a-100d of the articulations 9a-9d and 10a-10d to adjust the position of the wheels 11a-11d in contact with the ground 16, 17, 34, 36 so that the angle of inclination of the seat 3 relative to the horizontal (X, Y) is less than a particular angle value stored in the memory space of the control means 19. This enables the control means 19 to control the horizontality of the seat 3 by controlling the actuators 90a-90d and 100a-100d.

As a function of orders from the passenger, the state of the system and obstacles 33, 35 in the environment as mentioned above, the computer of the control means 19 is therefore able to generate the appropriate commands and send them to the various actuators 90a-90d and 100a-100d of the articulations 9a-9d, 10a-10d of the legs 6a-6d and to the motors of the wheels 11a-11d.

The legs 6a-6d and the wheels 11a-11d are moreover coordinated by the computer. It is therefore not necessary for the passenger or the user to concern themselves with controlling each actuator or wheel motor 11a-11d or to ensure the stability of the wheelchair 1.

To summarize, all low level commands (controlling the actuators 90a-90d, 100a-100d and the wheel motors 11a-11d), medium level commands (in particular coordination of the legs 6a-6d, setpoints sent to the actuators 90a-90d and 100a-100d, surveillance of the stability of the wheelchair 1) are handled by the computer of the control means 19 thanks to feedback loops. Only simple high-level orders, i.e. go forward, stop, turn, reverse, raise or lower the seat, are given by the passenger via the control console 13.

Referring to FIGS. 1 to 3, the way in which the wheelchair 1 of the invention travels on flat terrain 34 is identical to that of a classic electric wheelchair 1: the legs 6a-6d supporting the wheels 11a-11d are at rest, i.e. the wheelchair 1 is in a lowered position, and only the wheel motors 11a-11d are activated. The vision system 15 is not necessary for this mode of operation.

FIGS. 6 and 7 show the wheelchair 1 when the seat 3 is in its raised position. To enable the wheelchair 1 to go from its lowered position to this raised position, in response to an order from the passenger, the control means 19 control the actuators 90a-90d and 100a-100d of the articulations 9a-9d, 10a-10d of the four legs 6a-6d to enable synchronized extension so that the seat 3 remains horizontal. In the end this makes it possible to lift the passenger.

It is interesting to note that thanks to the feedback loop concerned the control means 19 are able to compensate a loss of horizontality by accentuating the movement of one or more of the legs 6a-6d of the wheelchair 1.

This feedback loop, enabling the seat 3 to be maintained horizontal, is also used by said control means 19 during movement on sloping terrain 16 or banked terrain 17, as shown in FIGS. 4 and 5.

In a first time period, the computer detects the inclination of the seat 3 thanks to the information coming from the inclination detection means.

In a second time period, the computer corrects the inclination of the seat 3, and therefore of the wheelchair 1, by commanding the actuators 90a-90d and 100a-100d of the articulations 9a-9d, 10a-10d to extend the legs 6a-6d on the side to which the wheelchair 1 is leaning, and thus to reestablish the horizontality of the seat 3, i.e. until the angle of inclination is less than the particular value stored in the memory space of the control means 19.

The four legs 6a-6d therefore make it possible to correct the attitude in roll and in pitch and therefore to maintain the seat 3 horizontal: in moving up or down a slope 16 (FIG. 4), pitch being corrected by the length difference of the front legs 6a, 6b and the rear legs 6c, 6d, on banked ground 17 (FIG. 5), roll being corrected by the length difference of the lefthand legs 6b, 6c, and the righthand legs 6a, 6d.

The inclination is detected and corrected in real time, which ensures that the horizontality of the seat is maintained even in the event of continuous variation of the sloping or banked terrain 16, 17.

Another aspect of the invention concerns negotiating various obstacles 33, 35, whether these are recesses, bosses 33, stairs 36, or even entry of the wheelchair 1 into an automobile trunk without assistance. This autonomy of the wheelchair 1 and of the passenger in negotiating the various obstacles is provided on the one hand by the possibility for the computer of controlling the actuators 90a-90d and 100a-100d of the articulations 9a-9d, 10a-10d and the motors of the wheels 11a-11d independently of one another and on the other hand by maintaining the stability of the wheelchair 1 even if one of the wheels 11a-11d is not in contact with the ground 16, 17, 34, 36.

To ensure that the wheelchair 1 is stable in all circumstances, referring to FIG. 8A the computer determines in real time the evolution of the position of the center of gravity 18 of the wheelchair 1.

In a first time period, the computer determines the position of the center of gravity 18 of the wheelchair 1, depending directly on the dimensions and masses of the elements constituting the wheelchair 1 and the position of the legs 6a-6d and the wheels 11a-11d. Accordingly, thanks to information on the one hand stored in the memory space of the control means 19 and on the other hand coming from the position sensors associated with the actuators 90a-90d, 100a-100d of the articulations 9a-9d and 10a-10d concerned, the computer knows the coordinates of the center of gravity 18 in the frame of reference of the wheelchair 1, i.e. relative to the wheels 11a-11d.

In a second time period, the computer detects which wheels 11a-11d are bearing on the ground 16, 17, 34, 36 using information coming from the force sensors and defines the coordinates of a support polygon 30 formed by the projection of the coordinates in the frame of reference (X, Y, Z) of the wheelchair 1 of the wheels 11ap, 11bp, 11cp, 11dp in contact with the ground in the horizontal plane. For example in the case of a wheelchair 1 with four wheels (11a-11d) one of the wheels on which is lifted, the computer defines the support triangle 32 formed by the projection of the coordinates in the frame of reference (X, Y, Z) of the wheelchair 1 of the three wheels that remain in contact with the ground in the horizontal plane.

In a third time period, the control means 19 actuate the actuators 90a-90d, 100a-100d so that the projected coordinates 18p in said horizontal plane of the center of gravity 18 of the wheelchair 1 are included in the support polygon 30.

In fact, the presence of the projected coordinates of the center of gravity 18p inside the support polygon 30 ensures stable equilibrium of the wheelchair 1 and under these conditions there is no risk of said wheelchair 1 tipping or overturning. It is considered that the projected center of gravity 18p is also included in the support polygon 30 if said projected center of gravity 18p is situated on one of the edges of said support polygon 30.

The three successive steps described above are repeated so that the determination of the coordinates of the center of gravity 18p and the maintaining of its position in the support polygon 30 are carried out in real time using the feedback loop concerned.

As a result, and as emerges in the remainder of the description, stable equilibrium of the wheelchair 1 is assured in all circumstances, and particularly when negotiating obstacles.

Nevertheless, to be able to evaluate the change of position of the center of gravity 18 it is necessary for the computer to determine beforehand the initial coordinates of the center of gravity 18 of the wheelchair 1, in particular when there is a passenger on the seat 3.

Before the three steps described above the computer therefore executes a preliminary step, for example at the mission start, that makes it possible to determine the initial coordinates of the center of gravity 18, this preliminary step including the following successive substeps.

During the first substep, with the four wheels 11a-11d of the wheelchair 1 bearing on the ground 34 and the seat 3 horizontal, the control means 19 control the actuators 90a-90b, 100a-100b of the articulations 9a-9b, 10a-10b of the two front legs 6a, 6b to extend the latter in the longitudinal direction X, i.e. toward the front of the wheelchair 1. As a result, the center of gravity 18 of the vehicle 1 is situated in the vicinity of the rear part 23 of the vehicle 1.

During the second substep the control means 19 control the actuators 90a, 90b, 100a, 100b concerned to lift one of the two legs 6a, 6b extended during the first substep. By way of example, this is the righthand front leg 6a that is lifted and a fortiori the associated wheel 11a.

During the third substep the control means 19 control the actuators 90b, 100b of the extended leg 6b the wheel 11b on which is bearing on the ground 34 to fold it toward the mechanical structure 2. This is therefore the lefthand front leg 6b here. The wheel 11b concerned bearing on the ground 34 therefore moves progressively in the longitudinal direction X toward the wheelchair 1. Thus as this wheel 11b approaches the wheelchair 1, it approaches the center of gravity 18.

During the fourth substep, while the lefthand front leg 6b continues its movement toward the wheelchair 1, the seat 3 tilts forward at a given time. At that given time, using data coming from the means for detecting inclination of the seat 3, the computer detects a variation of the angle between the seat 3 and the horizontal plane that is greater than a particular value stored in the memory space of the control means 19. The computer then stores the coordinates of the wheels bearing on the ground 34 at this given time. In this precise case this means the lefthand front wheel 11b and the rear wheels 11c, 11d.

Now, at the moment when the seat 3 tilts forward, the center of gravity is positioned at the center of the straight line segment that extends from the front wheel 11b resting on the ground 34 to the rear wheel 11d on the opposite lateral side. Here this therefore means the lefthand front wheel 11b and the righthand rear wheel 11d. The computer then assigns coordinates to the center of gravity 18 of the wheelchair 1 relative to the coordinates of the three wheels 11b, 11c, 11d bearing on the ground 34 and with the passenger installed on the seat 3, those coordinates forming the initial coordinates of the center of gravity 18.

For this preliminary step to be carried out in complete safety, the maneuver is effected on flat terrain and the wheel 11a-11d concerned is lifted only a few centimeters during the first substep.

Of course, it is possible to carry out this preliminary step by first moving the rear leg 6c, 6d further away rather than the front legs 6a, 6b during the first substep. The execution of this preliminary step remains substantially the same, the control means 19 in this case adapting the control of the actuators concerned and the determination of the coordinates of the wheels concerned.

Finally, this preliminary step of determination of the initial coordinates of the center of gravity 18 of the wheelchair 1, which may be considered a calibration step, may be effected at any time by the passenger launching via the control console 13 an appropriate program stored in the memory space of the control means 19, that program executing the preliminary step described above.

This calibration step may equally be effected at any time by the computer, which observes the dynamic of the means for detection of inclination of the wheelchair and calculates the theoretical dynamic of the center of gravity 18 from its stored initial coordinates and the positions of the actuators during the mission of moving and negotiating obstacles. If an inconsistency is detected above a threshold stored in the control means 19 the computer can then trigger recalibration of the center of gravity 18 by means of the calibration step described above.

Referring to FIGS. 8A to 8C, a method of maintaining the stability of the wheelchair 1 in the event of lifting one of the front wheels 11a-11d of the wheelchair 1 is described now. In order to ensure clarity for the reader, tolerated hereinafter is the abuse of language consisting in citing merely the center of gravity 18 and no longer its projected coordinates 18p.

The wheelchair 1 being in a position shown in FIG. 8A, i.e. with the four wheels 11a-11d bearing on the ground, the support polygon 30 is a quadrilateral 31 and the center of the gravity 18p is substantially located at the level of the crossing of the diagonals 31a of the quadrilateral 31 for optimum stability of the wheelchair 1. It is of course obvious for the person skilled in the art that for a wheelchair including a different number of wheels, for example six wheels, in this precise case where all the wheels are in contact with the ground the support polygon will be a hexagon. Generalizing this, if the wheelchair has N wheels and all the wheels are in contact with the ground, the support polygon is a polygon with N vertices.

Before lifting the righthand front wheel 11a (FIG. 8B), the computer selects the wheels that are to remain in contact with the ground in order to define the coordinates of the corresponding support triangle 32. The control means 19 then command the corresponding actuators to move the center of gravity 18p into the new support polygon 30, namely the triangle 32 formed by the projection of the coordinates of the wheels that in the end remain in contact with the ground 34, i.e. the two rear wheels 8c, 8d and the lefthand front wheel 8b (FIG. 8C). FIG. 8B shows clearly that the control means 19 control the movement of the seat 3 of the wheelchair 1 toward the rear wheels 8c, 8d (by moving apart the first segments 7a, 7b and the second segments 8a, 8b of the front legs 6a, 6b and by moving apart the first segments 7c, 7d and the second segments 8c, 8d of the rear legs 6c, 6d), which moves commensurately the center of gravity 18.

As soon as the computer calculates that the center of gravity 18p is indeed inside the previously defined support triangle 32, the control means 19 command lifting of the righthand front wheel 11a.

As shown in FIGS. 8D and 8E, any wheel 11a-11d of the wheelchair 1 may be lifted independently of the others, provided that the control means 19 enable movement before this of the center of gravity 18p the new support triangle 32 concerned following the lifting of the corresponding wheel.

This fundamental process, making it possible to maintain the stability of the wheelchair 1, enables any leg 6a-6d of the wheelchair 1 to be lifted, in that the control means 19 ensure that the wheelchair 1 is placed in a situation of static stability on the three wheels that have remained bearing on the ground. Permanent and optimum safety is therefore assured to the passenger in the wheelchair 1, whether the latter is merely rolling along or negotiating obstacles.

It is obvious to the person skilled in the art that for a wheelchair including a different number of wheels, for example six wheels, then the support polygon in this precise case, where one of the wheels is intended to be lifted, will be a pentagon. Generalizing, if the wheelchair has N wheels and one of the wheels is intended to be lifted off the ground, the resulting support polygon has N−1 vertices.

Referring to FIGS. 9A to 9D, a process of negotiating a single obstacle 33, for example a step, a pavement or the floor of the rear trunk of an automobile vehicle, is performed as follows for a wheelchair 1 in continuous movement throughout negotiating the obstacle 33.

In a first step, the 3D vision system 15 detects the presence of an obstacle 35 in the direction in which the wheelchair 1 is moving, for example in front of the wheelchair 1 when the latter is moving forward, as shown in FIG. 9A. In this instance, the obstacle 33 being a step, the control means 19 commands the movement of the wheelchair 1 to its raised position, as described above. This elevation step does not take place in the case of negotiating a gutter.

On the basis of information coming from the vision system 15 the computer controls the coordinates of the obstacle 33 in the frame of reference of the wheelchair 1 to obtain at last one height datum (vertical coordinate) and the distance separating the obstacle 33 from the wheel closest to said obstacle 33. The computer thus determines in real time this distance separating the obstacle 33 from the wheel 11a-11d. It also determines if the height of the obstacle 33 allows the front part 23 and the footrest 5 of the wheelchair 1 to pass over it. The maximum height of an object 33 that can be negotiated is typically the sum of the length of the first segment 7a-7d and the second segment 8a-8d.

In a second step, as soon as the distance between the wheel 11a nearest the obstacle 33 and said obstacle is less than or equal to a particular value stored in the memory space of the control means 19, the latter command lifting of the wheel 11a concerned so that the latter is located above the summit of the obstacle 33, the leg 6a associated with that wheel 11a being moved into a substantially horizontal extended position, and the wheelchair 1 continuing to move toward the obstacle 33. Referring to FIG. 9B, here this refers to the righthand front wheel 11a.

During the lifting of the righthand front wheel 11a, the control means 19 continue to act on the actuators 90b-90d and 100b-100d of the legs 6b-6d the wheels 11b-11d of which are still bearing on the ground 34 so as to continue to raise the seat 3 and also continue to act on the motors of the wheels 11a-11d so that the wheelchair 1 continues to move forward. The forward movement of the wheelchair 1 and the lifting of the wheel 11a are therefore effected continuously, with no jerking.

In a third step, as soon as the computer detects the presence of the righthand front wheel 11a lifted above the obstacle 33, the control means 19 command the placing of said wheel 11a on the summit of the obstacle 33 (FIG. 9B). During this movement the wheelchair 1 remains permanently in a situation of static stability on the other three wheels 11b-11d bearing on the ground 34, as described above for the process of maintaining the stability of the wheelchair 1.

The movement is similar in the case of a downward obstacle: lifting the wheel 11a and placing it on the step below or in the gutter. In all cases, the forward movement of the wheelchair 1 and the lowering of the wheel 11a are effected continuously, without jerking.

When the computer detects that the righthand front wheel 11a has come to bear on the summit of the obstacle 33, via the force sensor concerned, the control means 19 repeat the second and third steps of the process for the next wheel 11b nearest the obstacle 33 that has not yet negotiated it. Referring to FIG. 9C, this is the lefthand front wheel 11b. The conditions in respect of stability and forward movement of the wheelchair are identical to what has been described for the righthand front wheel 11a.

In a fourth step, and referring to the transition from FIG. 9C to FIG. 9D, when the front part 23 of the wheelchair 1 and its footrest 5 have negotiated the summit of the obstacle 33, the control means 19 reduce the extension of the front legs 6a, 6b and slow the forward movement of the front wheels 11a, 11b relative to the rear wheels 11c, 11d in order to move the center of gravity 18 forward and away from the center in accordance with the process for maintaining the stability of the wheelchair 1.

In order to prevent an impact between the front part 23 of the wheelchair 1 and the obstacle 33 the vertical distance separating the summit of the obstacle 33 from the lower part of the footrest 5 is greater than or equal to a margin the value of which is stored in the memory space. In the case of a descent into a gutter for example, this is the vertical distance separating the summit of the obstacle 33 from the lower portion of the rear part 20 of the wheelchair 1 that is greater than or equal to the margin.

In a fifth step, when the center of gravity 18p is in the support triangle 32 of the two front wheels 11a, 11b with the rear wheel 11c bearing on the ground 34, the control means 19 command lifting of the other rear wheel 11d and then putting it down on the obstacle 33 by acting on the actuators 90d and 100d of the leg 6d concerned.

Finally, this fifth step is repeated for the negotiation of the final wheel 11c, i.e. the lefthand rear wheel 11c. Of course, before lifting this final wheel 11c, the control means 19 have controlled the movement of the center of gravity 18p into the support triangle 32 the vertices of which are represented by the points at which the other three wheels 11a, 11b, 11d bear on the summit of the obstacle 33.

Accordingly, whilst lifting one wheel 11a-11d at a time, the control means 19 have enabled the wheelchair to negotiate without difficulty the single obstacle 33 in a fluid manner and with no jerking or impact.

As mentioned above, the wheelchair of the invention is also capable of climbing or descending steps 35. Referring to FIGS. 10A to 10F, a process of climbing a staircase 35 is carried out as follows for a wheelchair 1 in continuous movement throughout the climbing of the staircase 35.

FIGS. 10A to 10F thus show a nonlimiting example of kinematic negotiation enabling negotiation (climbing) of the staircase 35 by a succession of steps of permanent static stability by applying the process of maintaining stability described above. The first four steps defined hereinafter are not represented in FIGS. 10A to 10F, however.

In a first step, on approaching the staircase 35, the 3D vision system 15 detects the presence of said staircase 35 in front of the wheelchair 1. In this instance, the control means 19 commands the movement of the wheelchair 1 to its raised position, as described above. This elevation step does not take place in the situation that is not shown of descending a staircase 35.

On the basis of information coming from the vision system 15 the computer commands the coordinates in the frame of reference of the wheelchair of the first steps 36 to obtain at least one height datum (vertical coordinate) of each step, the depth of each step 36 and the distance separating the first step from the wheel closest to that step. Thus the computer determines in real time this distance separating the first step from the wheel. It also determines if the height of the step allows the front part 23 and the footrest 5 of the wheelchair 1 to pass over it.

In a second step, as soon as the distance between the wheel closest to the step 36 and said step is less than or equal to another particular value stored in the memory space of the control means 19, the latter command lifting of the wheel 11 11d concerned so that the latter is located above the top of the step 36. This will mostly be a front wheel 11a, 11b because the wheelchair 1 is adapted to negotiate staircases 35 when moving forward, whether climbing or descending.

During the lifting of the first front wheel 11a, the control means continue to act on the actuators 90b-90d and 100b-100d of the legs 6b, 6c, 6d the wheels 11b, 11c, 11d of which are still bearing on the ground so as to continue to raise the seat 3, and also on the motors of the wheels 11a-11d so that the wheelchair 1 continues to move forward. Thus the forward movement of the wheelchair 1 and the raising of the wheels 11a are effected continuously, without jerking.

In a third step, as soon as the computer detects the presence of the righthand front wheel 11a lifted above the first step 36, the control means 19 command the placing of said wheel 11a on top of the step 36 concerned. During this movement the wheelchair 1 remains permanently in a situation of static stability on the other three wheels 11b, 11c, 11d bearing on the ground, as described above for the process for maintaining the stability of the wheelchair 1.

The movement is similar in the case of a first downward step 36: lifting the wheel 11a and placing it on the step 36 below. In all cases, the forward movement of the wheelchair 1 and the descent of the wheel are effected continuously, without jerking.

In a fourth step, when the computer detects that the first front wheel 11a has come to bear on the top of the first step 36, via the force sensor concerned, the control means 19 control the actuators 90a-90d and 100a-100d so that the mechanical structure 2 of the wheelchair advances above the first step 36. This means that the height of the footrest 5 is greater than the height of the riser 37 of the step 36 concerned to prevent any impact between the footrest 5 and the next step 36, i.e. the second step.

The computer then repeats the second, third and fourth steps of the method for the next wheel 11b closest to the first step 36 that has not yet negotiated it, i.e. the other front wheel 11b. The conditions of stability and of forward movement of the wheelchair 1 are identical to what has been described for the righthand front wheel 11a.

As long as the depth of the step 36 is less than the distance separating the rear wheel 11c, 11d closest to the riser 37 from the first step 36, the second, third and fourth previous steps are repeated so that only the two front wheels 11a, 11b are successively placed on the steps of the staircase 35. The number of steps 36 that will be negotiated only by the front wheels 11a, 11b in a first time period depends on the steepness of the staircase 5.

Referring to FIG. 10A, as soon as the distance separating the closest rear wheel 11c, 11d from the riser 37 is less than or equal to the depth of the step 36 on which the two front wheels 11a, 11b are resting, then the control means 19 initiate the subsequent steps of the process consisting in climbing the staircase 35 with the aid of the four wheels 11a-11d, the rear wheels 11c, 11d of the wheelchair 1 no longer being able to turn from here on.

The computer memorizes progressively the depth and the height of the riser 37 of each depth 36. Also, the motors of the of four wheels 11a-11d are controlled so as to immobilize the wheels 11a-11d.

In a fifth step shown in FIG. 10A the control means 19 carry out the process for maintaining stability to move the center of gravity 18p of the wheelchair into the support triangle 32 formed by the projections of the two front wheels 11ap, 11bp and the rear wheel continuing to bear on the ground, i.e. the lefthand rear wheel 11cp.

In a sixth step the control means 19 then command lifting of the righthand rear wheel 11d, the wheelchair 1 being stable on the other three wheels 11a-11c. By simultaneous commands to the actuators 90d, 100d of the righthand rear leg 6 it then carries out for that wheel 11d the successive three substeps:

vertical lifting slightly higher than the step 36 to be negotiated;

horizontal forward movement above the step 36 to be negotiated;

vertical descent up to placing on the step 36 negotiated in this way, as detected by the corresponding force sensor.

The wheelchair 1 therefore arrives in the position shown in FIG. 10B, starting from which the seventh step of the process is carried out to move the center of gravity 18p of the wheelchair 1 into the support triangle 32 formed by the projections of the two rear wheels 11cp, 11dp and the front wheel 11bp continuing to bear on the ground, i.e. the lefthand front wheel. Actually, the control means 19 stabilize the wheelchair before lifting the righthand front wheel 11a in accordance with the process for maintaining the stability of the wheelchair 1 described above.

In the same manner as in the preceding step, the control means 19 then command lifting of the righthand front wheel 11a, the wheelchair being stable on the other three wheels 11b 11c. By simultaneous commands to the actuators 90a, 100a of the righthand front leg 11a, the control means 19 thus carry out for this wheel 11a the three successive substeps described in the preceding step.

The wheelchair 1 therefore arrives in the position shown in FIG. 10C, in which the center of gravity 18p is in the rear part of the support quadrilateral 31. The eighth step of the process is then carried out to move the center of gravity 18p of the wheelchair into the support triangle 32 formed by the projections of the two front wheels 11ap, 11bp and the rear wheel continuing to bear on the ground, i.e. the righthand rear wheel 11dp. Actually, the control means 19 stabilize the wheelchair 1 before lifting the lefthand rear wheel 11c, in accordance with the process of maintaining stability. The wheelchair 1 is then in the position shown in FIG. 10D.

In the same manner as in the sixth step, the control means 19 then command lifting of the lefthand rear wheel 11c, the wheelchair 1 being stable on the other three wheels 11a, 11b, 11d. By simultaneous commands to the actuators 90a, 100a of the righthand front leg 6a the control means 19 therefore perform for that wheel 11a the three successive substeps described in step six.

The wheelchair thus arrives in the position shown in FIG. 10E in which the control means 19 move the lefthand front wheel 11b. The center of gravity 18p being already in the support triangle 32 formed by the projections of the two rear wheels 11cp, 11dp and the righthand front wheel 11ap, the control means 19 do not need to command the movement of said center of gravity 18 before lifting the wheel 11b concerned.

In the same manner as in the sixth step, the control means 19 then command lifting of the lefthand front wheel 11b, the wheelchair 1 being stable on the other three wheels 11a, 11c, 11d. By simultaneous commands to the actuators 90a, 100a of the righthand front leg 6a the control means 19 carry out for that wheel 11a the three successive substeps described in step six.

The wheelchair 1 therefore arrives in the position shown in FIG. 10F in which the center of gravity 18p is in the rear part of the support quadrilateral 31. The ninth step of the process is then carried out to move the center of gravity 18p of the wheelchair 1 into the support triangle 32 formed by the projections of the two front wheels 11ap, 11bp and the rear wheel continuing to bear on the ground, i.e. the lefthand rear wheel 11cp. Actually, the control means 19 stabilize the wheelchair 1 before lifting the righthand rear wheel 11d, in accordance with the process for maintaining stability. The wheelchair 1 is then again in the position shown in FIG. 10A, and the cycle repeats until the staircase 35 has been negotiated completely.

Although not shown, this process applies equally for descending a staircase 35 and the steps described above are applied in substantially the same manner, except for the difference that in the sixth step the control means 19 command lifting of the wheel concerned, the wheelchair 1 being stable on the other three wheels. By simultaneous commands to the actuators of the wheel concerned, it therefore carries out for that wheel the three successive substeps:

vertical lifting so that the corresponding force sensor no longer senses the contact of the wheel on the step 36;

horizontal forward movement over the step 36 below;

vertical descent until placement on the step negotiated in this way, detected by the force sensor concerned.

Throughout the steps of the method described above the control means control all of the actuators 90a-90d and 100a-100d of the articulations 9a-9d, 10a-10d to cause the wheelchair 1 to rise or to descend while it remains stable and the seat 3 remains horizontal.

The limit for the negotiation of a staircase 35 by the wheelchair 1 of the invention is not determined by the height of each step 36 or by the limit of adhesion to two successive noses of steps 36 of a caterpillar track, as is notably the case in the prior art documents, but only by the mean slope on the staircase 35: the only limiting condition is to ensure the horizontality of the seat 3 by compensation for the slope of the staircase 35 thanks to the difference between the retraction of the front legs 6a, 6b (or rear legs 6c, 6d for the descent) and the extension of the rear legs 6c, 6d (or front legs 6a, 6b for the descent).

Moreover, the wheelchair of the invention enables the heavy elements of the wheelchair 1 to be fixed under the seat 3, thus lowering the center of gravity 18 of the wheelchair and improving its stability. Moreover, thanks to the mounting of the first segments 7a-7d on the exterior 200 of the mechanical structure 2 the lateral stability of the wheelchair 1 is also improved since the bearing points formed by the wheels 11a-11d are outside the polygon formed by projection onto the ground of the plane of the lower part 20 of the structure 2. Finally, the wheelchair 1 according to the invention enables negotiation of obstacles 33 of large size with dimensions that exceed those of the steps 36 of staircases or sidewalks.

The wheelchair 1 of the invention more particularly brings the following advantages:

it enables fluid transition between the rolling phase and the negotiation phase of the wheelchair 1 because it carries out all the negotiations in forward movement and is configured permanently and continuously thanks to the feedback loops; it is therefore not necessary to stop the wheelchair 1 to pass from one phase to the other;

it enables smooth negotiation of the obstacles 33, 35 thanks to its three-dimensional vision system that enables adaptation to the environment without coming into contact with the obstacles;

it enables horizontality to be maintained permanently in roll and in pitch, including when moving, thanks to the differential control of retraction/extension of the four legs 6a-6d slaved to the seat inclination sensor;

it enables negotiation of obstacles 33 of great height because the limit is of the order of the height of the unfolded legs 6a-6d; therefore much greater than in prior art systems;

it enables a recessed obstacle to be negotiated by passing from one side of it to the other without having to descend fully thanks to the lengthening of the legs 6a-6d horizontally and the off-center center of gravity 18;

it enables the seats 3 to be raised to the height of a standing person thanks to the simultaneous extension of the four legs 6a-6d;

it enables excellent lateral stability to be achieved thanks to the position of its bearing points outside of the wheelchair;

it enables excellent stability to be obtained thanks to a center of gravity 18 lowered by positioning low down, under the seat 3, heavy parts such as the battery (not shown);

it enables the stability of the wheelchair 1 to be made safe by maintaining the wheelchair 1 permanently in static stability on at least three supports during negotiation and four supports in other situations;

it alone provides all of the functionalities described above. It is therefore not necessary to add to this wheelchair 1 a supplemental device or to enlist the aid of a third party to obtain such or such a functionality.

The present invention is in no way limited to the use of this example of a process of permanently maintaining a condition of static stability as described and shown. Actually, the invention also enables successive movements of lifting the legs and the wheels to be effected in a different order or producing a more dynamic kinematic by accepting lifting of wheels under conditions slightly unstable statically but controlled dynamically by the speed of execution and the overall inertia of the device. In all cases, there exists a safety margin that consists in being able to put down again rapidly the wheel 11a-11d being lifted if a tilting movement is detected by the inclination sensor.

The mobility assistance vehicle 1 of the invention is not limited to a wheelchair, but may equally be a child's stroller or if appropriate a carriage for transporting goods or persons. The present invention is in no way limited to the embodiment described and shown.

1. A mobility assistance vehicle adapted to negotiate obstacles, including comprising:
a mechanical structure having opposite lateral sides and supporting at least one support plate,
control means,
at least four articulated legs each including first segments and second segments interconnected by a first motorized articulation, one end of each first segment being mounted on the mechanical structure, and
motorized wheels respectively mounted on respective free ends of the second segments
wherein
each of the first segments is mounted on one of the lateral sides of the mechanical structure via a second motorized articulation, each of the opposite lateral sides being connected to at least two legs, and
the control means are adapted to control independently of one another the first motorized articulations and the second motorized articulations of the legs.

2. The vehicle as claimed in claim 1, wherein each of the first segments is mounted in a lower part of the mechanical structure.

3. The vehicle as claimed in claim 1, wherein each of the first and second motorized articulations is driven by a dedicated actuator controlled by the control means.

4. The vehicle as claimed in claim 3, wherein each of the actuators includes a respective position sensor connected to the control means so that the control means know and control in real time spatial coordinates of each of the wheels of the vehicle relative to the mechanical structure of the vehicle.

5. The vehicle as claimed in claim 4, wherein the vehicle includes means for detecting inclination of a support blade relative to a horizontal plane, the inclination detection means being connected to the control means, and wherein the control means are adapted to control the actuators to adjust the position of the legs the wheels of which are in contact with the ground so that an angle of inclination of the support blade relative to the horizontal plane is less than a particular angle value.

6. The vehicle as claimed in claim 4, wherein the control means are adapted to calculate in real time the spatial coordinates of the center of gravity of the vehicle from data coming from the position sensors of the actuators.

7. The vehicle as claimed in claim 6, wherein the control means are adapted, before lifting one of the legs, to control a position of a center of gravity of the wheelchair by commanding the actuators to modify the position of the legs so that projected coordinates of the center of gravity in a horizontal plane are included within a support polygon defined by projected coordinates of the wheels intended to remain in contact with the ground in the plane after lifting the leg concerned.

8. The vehicle as claimed in claim 1, herein the vehicle includes a three-dimensional vision system controlled by the control means and adapted to detect at least one obstacle to be negotiated by the vehicle, the vision system enabling determination of the distance from the obstacle to the vehicle and at least one vertical coordinate of the obstacle representing a height of the obstacle.

9. The vehicle as claimed in claim 1, wherein each of the articulations of the legs include includes at least one substantially horizontal and transverse rotation axis.

10. The vehicle as claimed in claim 1, wherein the support plate is a seat of the vehicle.

11. A method for controlled negotiation of obstacles by successive raising of the legs of the vehicle as claimed in claim 1, wherein the method includes at least:
(i) determining, by the control means, of coordinates of a center of gravity of the vehicle as a function of various data coming from position sensors of actuators and as a function of dimensions and masses of elements constituting the vehicle and where necessary carried by the vehicle;
(ii) detecting, by the control means, of the wheels bearing on the ground as a function of data supplied by force sensors respectively fastened to the wheels and selecting, by the control means, of the wheels that are to continue to bear on the ground after lifting the wheel to be lifted;
(ii) defining coordinates of a support polygon formed by a projection of coordinates of the wheels remaining in contact with the ground in the horizontal plane;
(iv) actuating, by the control means, of the actuators to move the center of gravity so that the projected coordinates of the center of gravity are included in the support polygon previously defined, and
(v) lifting the wheel concerned, by the actuators concerned controlled by the control means.

12. The method as claimed in claim 11, wherein the successive actions (i) to (iv) are repeated in a loop so that the determination of the coordinates of the center of gravity and the maintaining of the position of the center of gravity in the corresponding support polygon are carried out in real time and in each of the actions (i) to (iv) of the loop.

13. The method as claimed in claim 11, wherein the support polygon defined before lifting the wheel concerned is a triangle, the vehicle having four legs.

14. The method as claimed in claim 13, wherein the method includes a preliminary action of determining initial coordinates of the center of gravity of the vehicle including at least the following sub-action:
(i) actuating, by the control means, of the actuators of the articulations of the two front or rear legs to extend the latter in a longitudinal direction so that the center of gravity of the vehicle is situated in a vicinity of a front part or a rear part of the vehicle, the wheels all bearing on the ground and the support plate being horizontal;
(ii) lifting, by the actuators concerned controlled by the control means, of one of the two extended legs of the vehicle to lift the wheel concerned;
(iii) actuating, by the control means, of the actuators of the articulations of the extended leg the wheel of which is bearing on the ground so as to move the leg concerned progressively toward the vehicle;
(iv) determining, by the control means, of the coordinates of the wheels bearing on the ground from the data coming from the position sensors of the articulations at the moment when the angle of inclination of the support plate relative to the horizontal plane reaches a particular value, the angle variation being analyzed by the control means with the aid of the data coming from the means for detection of inclination of the support plate;
(v) assigning coordinates to the center of gravity of the vehicle relative to the coordinates of the wheels bearing on the ground determined in the preceding action to form the initial coordinates of the center of gravity.

15. The vehicle as claimed in claim 1, wherein the control means are adapted to control independently of one another the first motorized articulations and the second motorized articulations of the legs by successively lifting the legs to negotiate an obstacle.

16. The vehicle as claimed in claim 15, wherein each of the actuators is an electric motor.

17. The vehicle as claimed in claim 15, wherein each of the actuators is a hydraulic or electric cylinder.

18. The vehicle as claimed in claim 2, wherein the control means are adapted to control independently of one another the first motorized articulations and the second motorized articulations of the legs by successively lifting the legs to negotiate an obstacle.

19. The vehicle as claimed in claim 18, wherein each of the actuators is an electric motor.

20. The vehicle as claimed in claim 18, wherein each of the actuators is a hydraulic or electric cylinder.
